(19) United States
(12) Patent Application Publication
(10) Pub. No.: US 2026/0259480 A1
(43) Pub. Date: Sep. 3, 2026

(54) OPTICAL COMPONENT, CAMERA, AND VEHICLE

(71) Applicant: KYOCERA Corporation, Kyoto-shi, Kyoto (JP)

(72) Inventors: Masaomi SATO, Yokohama-shi, Kanagawa (JP); Hiroyuki ABE, Yokohama-shi, Kanagawa (JP)

(73) Assignee: KYOCERA Corporation, Kyoto-shi, Kyoto (JP)

(21) Appl. No.: 18/870,842

(22) PCT Filed: Jun. 1, 2023
(86) PCT No.: PCT/JP2023/020523

§ 371 Date: Dec. 2, 2024

(30) Foreign Application Priority Data
Jun. 20, 2022 (JP) 2022-099224

(51) Int. Cl. G03B 17/56; G03B 17/08

(52) U.S. Cl. CPC G03B 17/55; G03B 17/08; G03B 17/56

(57) ABSTRACT

An optical component (100) covers an optical system (210) of a camera (200). The optical component (100) includes an optical member (10) and a heat element (20). The optical member (10) includes a first region (11a) and a second region (11b). The first region (11a) allows an electromagnetic wave entering the optical system from within an angle of view of the optical system (210) to pass through. The heat element (20) heats a second space (12b) to be a temperature higher than a temperature of a first space (12a). The first space (12a) is defined on a side closer to the camera by the first region (11a). The second space (12b) is in communication with the first space (12a) and defined on the side closer to the camera by the second region (11b).

### CROSS-REFERENCE TO RELATED APPLICATIONS

The present application claims priority to Japanese Patent Application No. 2022-099224 filed on Jun. 20, 2022, which is incorporated herein by reference in its entirety.

### DESCRIPTION

### Technical Field

The present disclosure relates to an optical component, a camera, and a vehicle.

### Background of Invention

A known camera includes an optical component that covers an optical system (see Patent Literature 1).

### CITATION LIST

### Patent Literature

Patent Literature 1: Japanese Unexamined Patent Application Publication No. 6-258713.

### SUMMARY

### Solution to Problem

In an embodiment, an optical component covers an optical system of a camera. The optical component includes an optical member and a heat element. The optical member includes a first region and a second region. The first region allows an electromagnetic wave entering the optical system from within an angle of view of the optical system to pass through. The heat element heats a second space to be a temperature higher than a temperature of a first space. The first space is defined on a side closer to the camera by the first region. The second space is in communication with the first space and defined on the side closer to the camera by the second region.

In an embodiment, a camera includes an optical system, a lens holder, an optical member, a wall body, and a heat element. The lens holder holds the optical system. The optical member covers the optical system and includes a first region and a second region. The first region allows an electromagnetic wave entering the optical system from within an angle of view of the optical system to pass through. The wall body defines a first space together with the first region of the optical member and defines a second space together with the second region of the optical member. The heat element is positioned at the second space.

In an embodiment, a vehicle includes a camera. The camera includes an optical system, a lens holder, an optical member, a wall body, and a heat element. The lens holder holds the optical system. The optical member covers the optical system and includes a first region and a second region. The first region allows an electromagnetic wave entering the optical system from within an angle of view of the optical system to pass through. The wall body defines a first space together with the first region of the optical member and defines a second space together with the second region of the optical member. The heat element is positioned at the second space.

### BRIEF DESCRIPTION OF THE DRAWINGS

FIG. 1 is a certain partial sectional view of an optical component and a camera according to a first embodiment.

FIG. 2 is a plan view of a vehicle according to the first embodiment.

FIG. 3 is a perspective view illustrating a first example of an optical member of the optical component according to the first embodiment.

FIG. 4 is a certain sectional view illustrating a second example of an optical member of the optical component according to the first embodiment.

FIG. 5 is a perspective view illustrating a third example of an optical member of the optical component according to the first embodiment.

FIG. 6 is a certain sectional view illustrating a first example of an optical member of an optical component according to a second embodiment.

FIG. 7 is a certain sectional view illustrating a second example of an optical member of the optical component according to the second embodiment.

FIG. 8 is a plan view illustrating a first example of an optical member of an optical component according to a third embodiment.

### DESCRIPTION OF EMBODIMENTS

Hereinafter, embodiments of an imaging unit to which the present disclosure is applied are described with reference to the drawings.

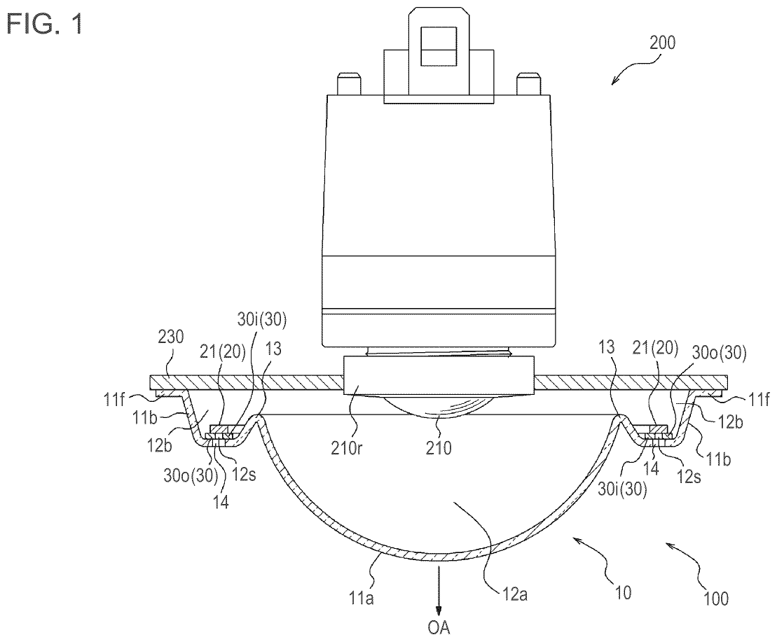

FIG. 1 is a certain partial sectional view of a camera including an optical component according to a first embodiment. A camera 200 includes an optical system 210, a wall body 230, and an optical component 100. The camera 200 may further include an imaging sensor.

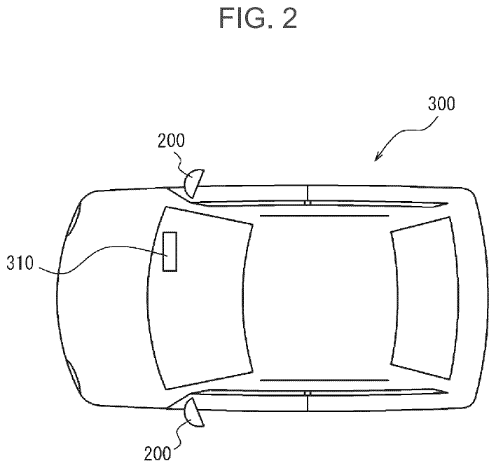

The camera 200 may be a car-mounted camera. With reference to FIG. 2, the vehicle 300 may include the camera 200 mounted thereon together with a display 310. The camera 200 may be secured to a side view mirror or the like of the vehicle 300 to capture an image of, for example, a ground or a periphery of a rear-side field of vision. The camera 200 may be attached to the vehicle 300 in a state in which the optical system 210 faces downward, obliquely downward, or a side. The display 310 may be provided in such a manner as to be visible from a driver's seat.

The optical system 210 may image-form, at the imaging sensor, a subject image in an imaging field of view. The optical system 210 may include at least one optical element. The optical system 210 may be designed and formed in such a manner as to satisfy desired optical characteristics including a focal length and a focal depth. The optical element may include a lens, a diaphragm, a mirror, and the like.

The camera 200 may include a retainer (lens holder) 210r that retains the lens (optical system). The retainer 210r may have a cylindrical shape. The retainer 210r may include a ring-shaped holding part formed to retain the lens. The retainer 210r may retain the lens in such a manner that an optical axis OA of the optical system 210 passes through a center of an opening defined by the ring of the holding part. Luminous flux that enters the lens may pass through the opening. The retainer 210r may be a resin member.

The wall body 230 may include a wall surface extending in a direction intersecting with a direction of the optical axis OA of the camera 200. For example, the wall body 230 may include, as the wall surface, a flat surface perpendicular to the optical axis OA. The wall body 230 may be provided at an arbitrary position in the optical axis OA direction. In the first embodiment, the wall body 230 may be provided at an outer edge of the optical system 210 when seen in the optical axis OA direction. The wall body 230 may have a disk shape. The wall body 230 may be used for coupling with the optical component 100 as will be described later. The wall body 230 may be a part of a structure of the vehicle 300. The structure may be a housing of a side view mirror.

The imaging sensor may be disposed on an image side of the optical system 210. The imaging sensor may capture a subject image image-formed on a light receiving surface via the optical system 210, and convert it into an electrical signal to be output. As the imaging sensor, for example, CCD (charge coupled device), CMOS (complementary metal oxide semiconductor) image sensor, or the like may be used. The camera 200 may transmit an image signal based on the electrical signal from the imaging sensor to, for example, a device outside of the camera 200, such as the display 310. The image signal may be the electrical signal itself output from the imaging sensor, or may be a signal that has undergone necessary image processing by an electronic component.

The optical component 100 includes an optical member 10 and a heat element 20. The optical component 100 may further include a cushion 30. The optical component 100 covers the optical system 210 of the camera 200.

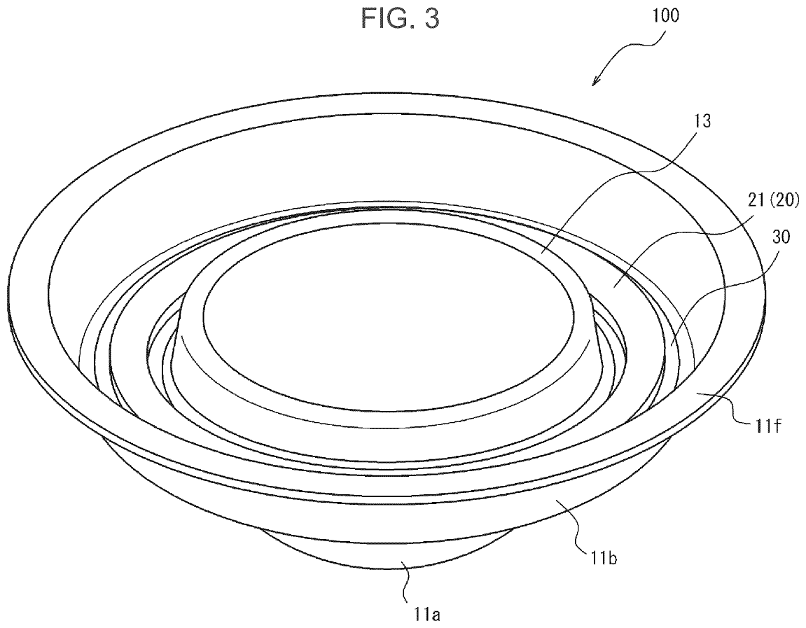

With reference to FIGS. 1 and 3, the optical member 10 includes a first region 11a and a second region 11b. The optical member 10 may further include a flange 11f, a partition part 13, and a drain hole 14. The optical member 10 may be a lens cover. In the camera 200, the optical member 10 may seal, together with the wall body 230, the optical system 210. The optical member 10 may include resin or glass. The optical member 10 may be positioned in the camera 200 on a subject side of the optical system 210. The optical member 10 with this configuration may reduce a possibility of wind, raindrops, and/or the like hitting the optical system 210. Accordingly, the optical member 10 may reduce a possibility of cooling of an outer surface of the optical system 210.

The first region 11a allows an entering electromagnetic wave to pass therethrough.

Specifically, in the camera 200, the first region 11a allows an electromagnetic wave entering the optical system 210 from within an angle of view of the optical system 210 to pass through. In the camera 200, the first region 11a, the camera 200, and an imaginary plane that passes an outer edge of the first region 11a and in parallel to the optical axis OA may define a first space 12a. The first region 11a may have a plate-like shape including a curved surface with a uniform thickness. The first region 11a may have a curved shape, and may further have a spherical shape, or may have a flat plate-like shape. For the sake of a reduction in size, the first region 11a preferably has a spherical shape. In the following description, the first region 11a has a spherical shape.

In the camera 200, the second region 11b couples with at least a part of the outer edge of the first region 11a when seen in the optical axis OA direction. In the camera 200, the second region 11b, the camera 200, and an imaginary plane that passes an outer edge of the second region 11b and in parallel to the optical axis OA may define a second space 12b.

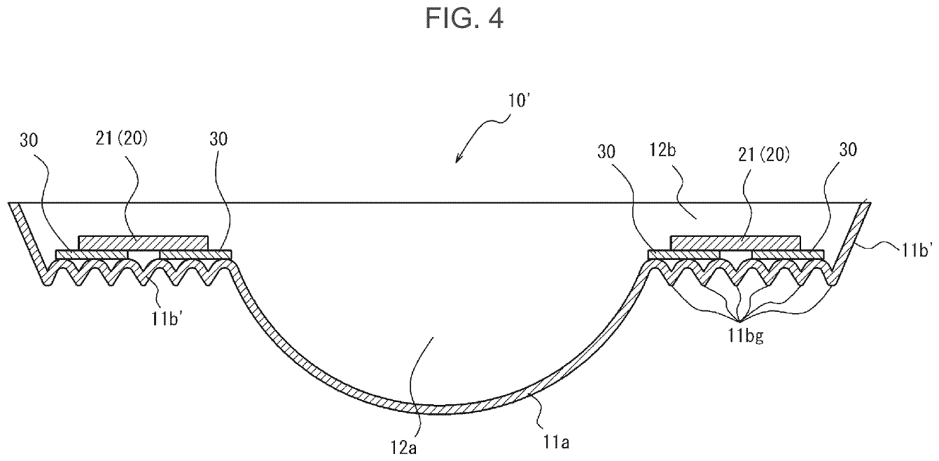

In the first embodiment, the second region 11b may be positioned in such a manner as to surround an entire circumference of the first region 11a. In other words, the second space 12b may surround the first space 12a when seen in the optical axis OA direction. In the configuration in which the first region 11a has a spherical shape, the outer edge of the first region 11a and the outer edge of the second region 11b may be concentric with one another in a plane perpendicular to the optical axis OA. The second region 11b may be a ring-shaped groove along the entire circumference of the first region 11a. With reference to FIG. 1, in the camera 200, this groove may dent to the subject side. The groove of the second region 11b may include a flat bottom surface. The groove may have a width that is reduced toward the bottom surface. This configuration allows water condensed at the second space 12b to flow along a side wall of the groove to reach the drain hole 14 described later in the state in which the optical system 210 of the camera 200 is attached in such a manner as to face downward or obliquely downward. The drain hole 14 is formed at the bottom surface of the groove. Alternatively, with reference to FIG. 4, a plurality of ring-shaped grooves 11bg may be provided at a second region 11b'. The plurality of ring-shaped grooves 11bg may be concentric with one another.

In the first embodiment, the flange 11f may have a form attachable to the wall body 230 of the camera 200. Specifically, the camera 200 includes a region where the flange 11f and the wall body 230 overlap with one another when seen from the optical axis OA.

Preferably, the entire region of the flange 11f overlap with the wall body 230. In the camera 200, the flange 11f may be provided at the outer edge of the second region 11b when seen from the optical axis OA. More specifically, in the camera 200, the flange 11f may be provided at the outer edge of the second region 11b over an entire circumference of the optical axis OA. The flange 11f may have a ring shape. In the camera 200, the flange 11f may be positioned at an utmost image side in the optical axis OA direction.

The partition part 13 may partially partition the first space 12a and the second space 12b. Specifically, in the camera 200, the partition part 13 may include a wall body that includes a gap at an image-side part in an overall region of a boundary between the first space 12a and the second space 12b. In the configuration in which the second region 11b has a ring shape, in the camera 200, the partition part 13 may have a shape including protrusion from the optical member 10 to the image side over the entire circumferential direction of the optical axis OA. In the camera 200, a top of the partition part 13 may be positioned at the subject side with respect to the flange 11f.

With reference to FIG. 1, the drain hole 14 may be formed at the second region 11b. The drain hole 14 may be a through-hole. The drain hole 14 may be positioned at a center of the bottom surface of the groove of the second region 11b. Condensed water may be discharged outside of the optical member 10 from the drain hole 14. The drain hole 14 may be openable and closable. When an amount of condensed water reaches a certain amount or more, the drain hole 14 may open.

In the first embodiment, the drain hole 14 may be positioned at the bottom surface of the ring-shaped groove of the second region 11b at intervals in a circumferential direction of the groove.

The heat element 20 may heat the second space 12b to be a temperature higher than a temperature of the first space 12a. The heat element 20 may include a heater 21. The heater 21 may generate heat by energization. In other words, the heater 21 may heat its surrounding space by energization. The heat element 20 may include a power terminal.

Alternatively, the heat element 20 may include a Peltier device. The Peltier device cools one side surface while heating another side surface by energization. In other words, the Peltier device may cool air around one side surface while heating air around another side surface by energization. Specifically, the Peltier device may cool air around a Peltier-device side surface that faces the second region 11b while heating air around a side surface at the opposite side to the second region 11b. In the configuration in which the Peltier device is adapted as the heat element 20, a cooling surface may be provided in such a manner as to face one surface of the second region 11b.

The heat element 20 may have any shape. With reference to FIG. 3, the heat element 20 may have a ring shape. The heat element 20 may be positioned on the second region 11b. The heat element 20 may be positioned on the bottom surface of the groove of the second region 11b.

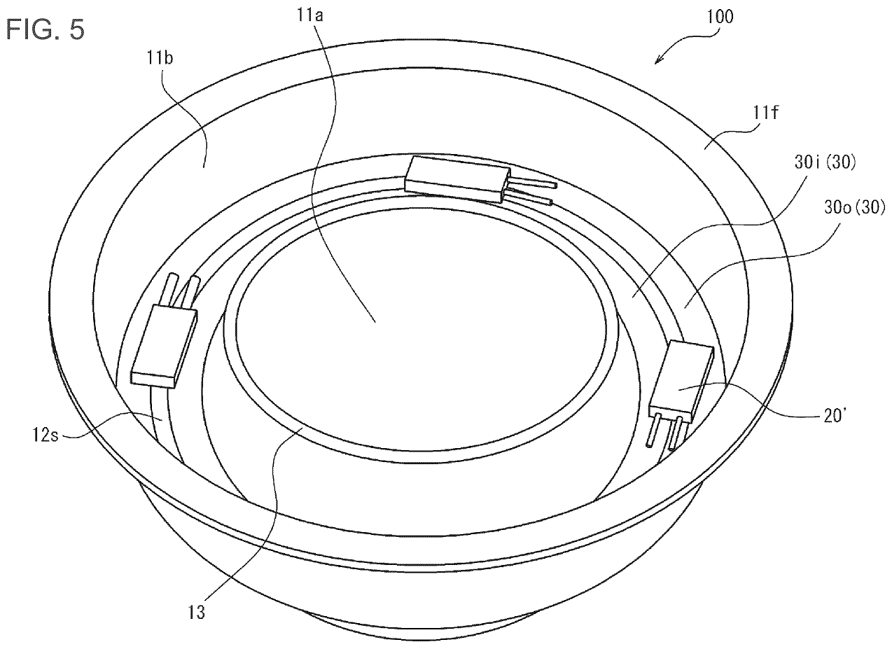

Alternatively, with reference to FIG. 5, a heat element 20′ may have a rectangular plate-like shape. The shape of the heat element 20′ is not limited to a rectangular shape, but may be a circle shape, for example. The number of heat element 20′ in the rectangular plate-like shape may be one, or more than one. In the optical member 10, a plurality of heat elements 20′ may be positioned on the bottom surface of the ring-shaped groove of the second region 11b at intervals in the circumferential direction of the groove.

The heat element 20 may be placed in such a manner as to include a gap 12s with respect to the optical member 10. Specifically, the heat element 20 may be secured to the second region 11b with the cushion 30 interposed therebetween. The cushion 30 may be provided on the bottom surface of the groove of the second region 11b of the optical member 10. The cushion 30 may be secured on the bottom surface of the groove of the second region 11b. The cushion 30 may be secured by using any securing measure, such as double-sided tape. A part of a surface of the heat element 20 may be in contact with the cushion 30. This surface faces the cushion 30. The gap 12s may be formed between the second region 11b and a remaining part of the facing surface other than the range in contact with the cushion 30. The cushion 30 may include an outer-side cushion 300 and an inner-side cushion 30i. The inner-side cushion 30i may be positioned closer to the partition part 13 than the outer-side cushion 300 is. The outer-side cushion 300 and the inner-side cushion 30i may extend in parallel to one another.

In the first embodiment, the outer-side cushion 300 and the inner-side cushion 30i may each have a ring shape. The gap 12s in a ring shape may exist between the heat element 20, the outer-side cushion 300, and the inner-side cushion 30i. The gap 12s may be in communication with the drain hole 14. For example, the outer-side cushion 300 and the inner-side cushion 30i may be disposed in such a manner that the gap 12s overlaps with the drain hole 14 when seen in the optical axis OA direction of the camera 200.

Below, effects achieved by the optical component 100 of this embodiment are described. Optical components 400 and 500 of embodiments described later also achieve the same and/or similar effects.

In this embodiment, the optical component 100 includes the heat element 20 that heats the second space 12b to be a temperature higher than a temperature of the first space 12a. The first space 12a is defined on the side closer to the camera 200 at least partially by the first region 11a, and the second space 12b is in communication with the first space 12a and defined on the side closer to the camera 200 at least partially by the second region 11b. The optical component 100 with this configuration may cause condensation at the second space 12b and reduce air humidity at the second space 12b. Therefore, humidity at the first space 12a that is in communication with the second space 12b may also decrease. Accordingly, the optical component 100 may reduce an amount of condensation caused at an inner surface of the first region 11a of the optical member 10, in other words, at the surface on the first space 12a side.

In the optical component 100 of this embodiment, the optical member 10 includes the partition part 13 that partially partitions the first space 12a and the second space 12b. The optical component 100 with this configuration may reduce an amount of flow of water condensed at the second space 12b to the first space 12a in the state in which the camera 200 is attached to the vehicle 300 or the like in such a manner that the optical system 210 faces downward.

In the optical component 100 of this embodiment, the gap 12s exists between the heat element 20 and the second region 11b of the optical member 10. The optical component 100 with this configuration may reduce a heat amount of the second region 11b by the heat element 20. Accordingly, warm air at the second space 12b may be further cooled on the second region 11b to cause condensation.

In the optical component 100 of this embodiment, the optical member 10 includes the drain hole 14 at the second region 11b. The optical component 100 with this configuration may discharge condensation caused at the second space 12b in the state in which the camera 200 is attached to the vehicle 300 or the like in such a manner that the optical system 210 faces downward.

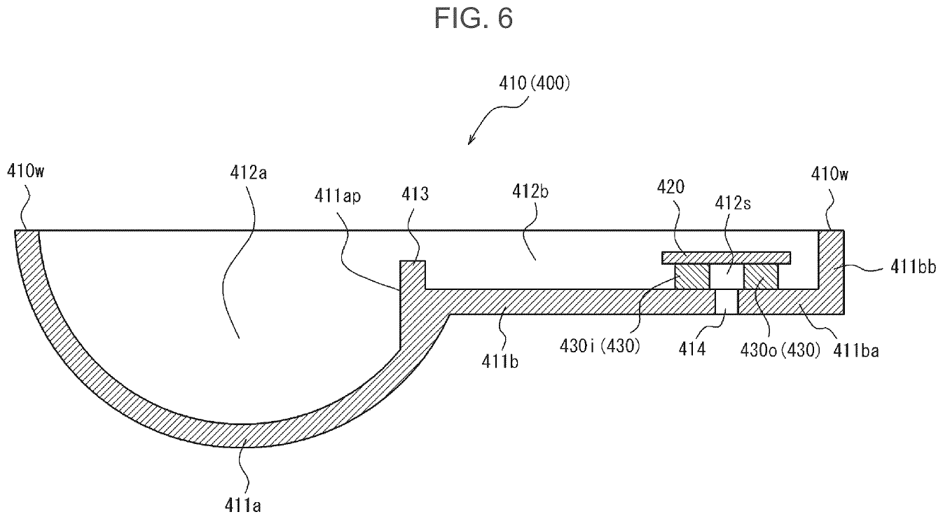

Next, an optical component according to a second embodiment is described. FIG. 6 is a certain sectional view of the optical component according to the second embodiment.

Below, the same configuration as the optical component 100 is not described once again, and a configuration different from that of the optical component 100 is described.

With reference to FIG. 6, in the camera 200, a first region 411a may include a flat surface 411ap that is in parallel to the optical axis OA. Further, the first region 411a may include a spherical surface that is cut by a plane perpendicular to the optical axis OA and the flat surface 411ap.

Unlikely to the first embodiment, in the second embodiment, a second region 411b may couple with a part of an outer edge of the first region 411a when seen in the optical axis direction of the camera. The second region 411b may be provided at the same position as the flat surface 411ap of the first region 411a in the circumferential direction of the optical axis OA of the camera 200. The second region 411b may have a box-like shape with one surface open. In the camera 200, the open surface of the second region 411b may be positioned at a side closer to the wall body 230 of the camera 200. In other words, a bottom surface opposed to the open surface may be positioned at the subject side in the camera 200. At a coupling portion of the second region 411b with the first region 411a, a part of a box-like shaped wall surface may be absent. More specifically, the second region 411b may include a rectangular plate 411ba. The second region 411b may include three side walls 411bb provided upright at an outer edge of the plate 411ba. The plate 411ba includes an outer edge that is adjacent to a partition part 413 and that may not include a side wall. The side walls 411bb may project to the image side in a state in which the camera 200 incorporates the optical component 400.

The above-described wall body including the flat surface 411ap of the first region 411a along the optical axis OA may function as the partition part 413. The partition part 413 may projects to the image side from an optical member 410 in a state in which the optical component 400 is attached to the camera 200. The partition part 413 may terminate to the image side at the subject side with respect to an outer circumferential wall 410w of the optical member 410 in the optical axis OA direction of the camera 200.

A heat element 420 may have a rectangular plate-like shape. In the second embodiment, the heat element 420 may be provided in a position within the second region 411b to be away from the first region 411a when seen in the optical axis OA direction of the camera 200.

Similarly to the first embodiment, in the second embodiment, the heat element 420 may be secured to a bottom part of the second region 411b with a cushion 430 interposed therebetween. The cushion 430 may include an outer-side cushion 4300 and an inner-side cushion 430i. A gap 412s between the outer-side cushion 4300 and the inner-side cushion 430i may be in communication with a drain hole 414 formed at the second region 411b.

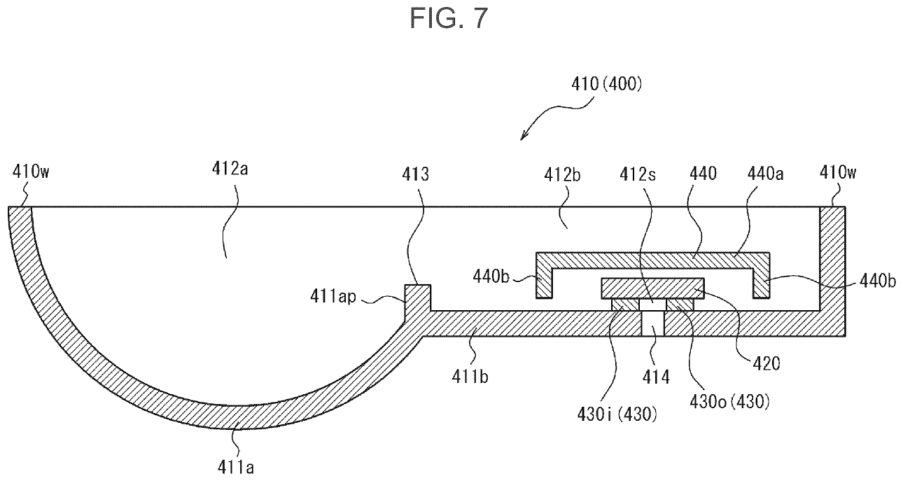

With reference to FIG. 7, a cover 440 may cover the heat element 420. The cover may have a box-like shape with one surface open. The cover 440 may be attached in such a manner that the open surface faces the second region 411b. A part of the cover 440 may be formed with a hole. These configurations may make warm air inside the cover 440 be less likely to flow out of the cover 440. Therefore, condensation may be likely to occur at a wall surface of the second region 411b inside the cover 440. The cover 440 may include a rectangular plate 440a and four side walls 440b provided upright at an outer edge of the plate 440a. In the camera 200, the side walls 410b may project to the subject side. The side walls 440b of the cover 440 and the second region 411b may include a gap therebetween. Condensed water may pass through the gap.

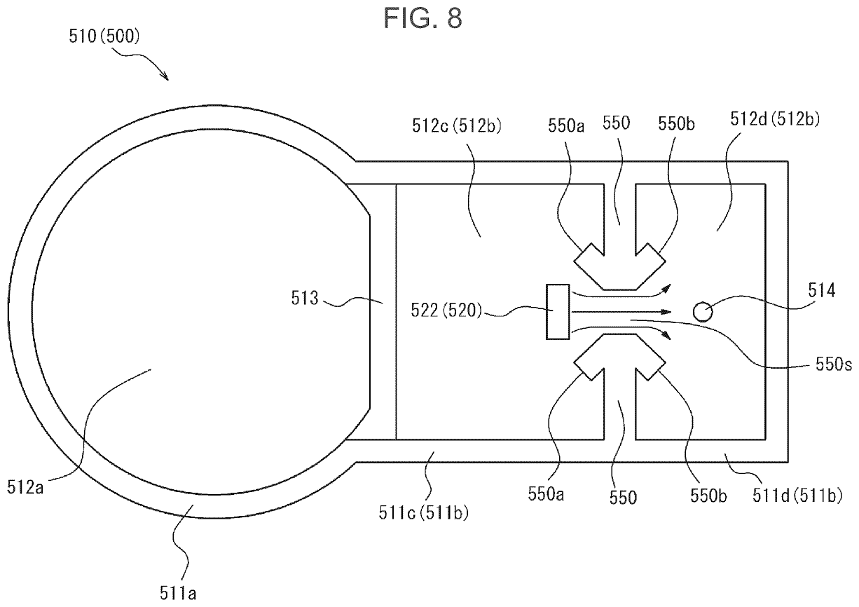

Next, an optical component according to a third embodiment is described. FIG. 8 is a plan view of the optical component according to the third embodiment. Below, the same configuration as the optical component 400 is not described once again, and a configuration different from that of the optical component 400 is described. An optical member 510 may further include a second partition part 550.

In the third embodiment, shapes of a first region 511a and a second region 511b of the optical member 510 may be similar to those of the second embodiment.

The second partition part 550 may be formed at the second region 511b. The second partition part 550 may divide a second space 512b into an inner-side second space 512c and an outer-side second space 512d in a separating direction from a first space 512a. The inner-side second space 512c is closer to the first space 512a than the outer-side second space 512d is. The second partition part 550 may have a flat plate-like shape in parallel to the optical axis OA direction of the camera 200. The second partition part 550 in a flat plate-like shape may be in parallel to a partition part 513. In the camera 200, the second partition part 550 may be in contact with the wall body 230.

A part of the second partition part 550 may be missing. Specifically, the second partition part 550 may be formed with a slit 550s. The slit 550s may be positioned at a center in a longitudinal direction of the second partition part 550. The second partition part 550 may be formed with barbs at both sides of a part facing the slit 550s. The barb may include a barb 550a projecting toward an inner-side second region 511c and a barb 550b projecting toward an outer-side second region 511d. An angle formed between an extending direction of each of the barbs 550a and 550b and the longitudinal direction of the second partition part 550 may be an acute angle.

The heat element 520 may include an air conditioner 522. The air conditioner 522 may blow warm air by energization. The air conditioner 522 may be positioned in the inner-side second region 511c. An outlet of the air conditioner 522 may face the slit 550s. Warm air from the air outlet of the air conditioner 522 may pass through the slit 550s and flow into the outer-side second space 512d. In the configuration in which the angle formed between the extending direction of the barb 550a and the longitudinal direction of the second partition part is an acute angle, the barb 550a may direct warm air from the air outlet of the air conditioner 522 to the slit 550s. This may make passing of the warm air through the slit 550s easier. The barb 550b may reduce an amount of flow of warm air that has flowed in the outer-side second space 512d, from the outer-side second space 512d to the inner-side second space 512c.

Alternatively, the heat element 520 may include a heater. The heater may be positioned at the outer-side second space 512d. The heater may be secured not on a bottom surface of the outer-side second region 511d but on the wall body 230 of the camera 200.

The outer-side second region 511d may be formed with a drain 514 at a center of the bottom surface of the outer-side second region 511d.

Although the present invention has been described based on the drawings and the embodiments, it is to be understood that those skilled in the art may easily vary or alter in multiple ways based on the disclosure of the present invention. Accordingly, it should be noted that such variation and alteration are included in the scope of the present invention.

### REFERENCE SIGNS

100, 400, 500 optical component
10, 410, 510 optical member
11a, 411a first region
11b, 411b, 511b second region
11bg groove
11f flange (outer edge part)
12a, 412a, 512a first space
12b, 412b, 512b second space
12s, 412s gap
13, 413, 513 partition part
14, 414, 514 drain hole
20, 420, 520 heat element
21 heater
30, 430 cushion
300 outer-side cushion
30i inner-side cushion
200 camera
210 optical system
210r retainer
230 wall body
300 vehicle
310 display
410w outer circumferential wall
411ap flat surface
411ba rectangular plate
411bb side wall
440 cover
511c inner-side second region
511d outer-side second region
512c inner-side second space
512d outer-side second space
522 air conditioner
550 second partition part
550a barb
550b barb
550s slit
OA optical axis

1. An optical component for covering an optical system of a camera, the optical component comprising:
an optical member comprising a first region and a second region, the first region allowing an electromagnetic wave entering the optical system from within an angle of view of the optical system to pass through; and
a heat element configured to heat a second space to be a temperature higher than a temperature of a first space, the first space being defined on a side closer to the camera by the first region, and the second space communicating with the first space and being defined on the side closer to the camera by the second region.

2. The optical component according to claim 1, wherein the optical member comprises a partition part configured to partially partition the first space and the second space.

3. The optical component according to claim 1, wherein a gap exists between the heat element and the second region of the optical member.

4. The optical component according to claim 1, wherein the second space surrounds the first space when seen in a direction of an optical axis of the optical system.

5. The optical component according to claim 1, wherein the optical member comprises a drain hole at the second region.

6. A camera comprising:
an optical system;
a lens holder configured to hold the optical system;
an optical member configured to cover the optical system and comprising a first region and a second region, the first region allowing an electromagnetic wave entering the optical system from within an angle of view of the optical system to pass through;
a wall body configured to define a first space together with the first region of the optical member and define a second space together with the second region of the optical member; and
a heat element positioned at the second space.

7. A vehicle comprising a camera, the camera comprising:
an optical system;
a lens holder configured to hold the optical system;
an optical member configured to cover the optical system and comprising a first region and a second region, the first region allowing an electromagnetic wave entering the optical system from within an angle of view of the optical system to pass through;
a wall body configured to define a first space together with the first region of the optical member and define a second space together with the second region of the optical member; and
a heat element positioned at the second space.

8. The optical component according to claim 2, wherein a gap exists between the heat element and the second region of the optical member.

9. The optical component according to claim 2, wherein the second space surrounds the first space when seen in a direction of an optical axis of the optical system.

10. The optical component according to claim 3, wherein the second space surrounds the first space when seen in a direction of an optical axis of the optical system.

11. The optical component according to claim 8, wherein the second space surrounds the first space when seen in a direction of an optical axis of the optical system.

12. The optical component according to claim 2, wherein the optical member comprises a drain hole at the second region.

13. The optical component according to claim 3, wherein the optical member comprises a drain hole at the second region.

14. The optical component according to claim 8, wherein the optical member comprises a drain hole at the second region.

15. The optical component according to claim 4, wherein the optical member comprises a drain hole at the second region.

16. The optical component according to claim 9, wherein the optical member comprises a drain hole at the second region.

17. The optical component according to claim 10, wherein the optical member comprises a drain hole at the second region.

18. The optical component according to claim 11, wherein the optical member comprises a drain hole at the second region.
